(19) United States
(12) Patent Application Publication
(10) Pub. No.: US 2017/0142296 A1
(43) Pub. Date: May 18, 2017

(54) VIDEO-PROCESSING APPARATUS AND VIDEO-PROCESSING METHOD

(71) Applicant: PFU LIMITED, Ishikawa (JP)

(72) Inventors: Takashi OKI, Kanagawa (JP); Takashi KIDAMURA, Ishikawa (JP)

(21) Appl. No.: 15/057,916

(22) Filed: Mar. 1, 2016

(30) Foreign Application Priority Data
Nov. 12, 2015 (JP) 2015-222219

(51) Int. Cl. H04N 5/06; H04N 5/14

(52) U.S. Cl. CPC H04N 5/06; H04N 5/14

(57) ABSTRACT

According to the present disclosure, when subdivided data in which a frame is subdivided is received via a network, values of the number of samples and the number of lines in a frame being output are acquired, and a video output clock is controlled based on the values and reference values of the number of samples and the number of lines as references for the video output clock.

### CROSS-REFERENCE TO RELATED APPLICATION

This application is based upon and claims the benefit of priority from Japanese Patent Application No. 2015-222219, filed on Nov. 12, 2015, the entire contents of which are incorporated herein by reference.

### BACKGROUND OF THE INVENTION

1. Field of the Invention

The present disclosure relates to a video-processing apparatus and a video-processing method.

2. Description of the Related Art

Conventionally, techniques for suppressing frame repeating and skipping have been disclosed.

Specifically, a technique for delaying the time of occurrence of missed or overlapping output signals based on a frequency difference between a clock in a receiving device and a clock in synchronization with a signal input from a transmitting device has been disclosed (see, JP-A-2009-171513).

Another technique by which, even in the event of a delay in transmission between paths or devices, the amount of data accumulated in a buffer at the receiving side is monitored and the clock frequency is dynamically changed to minimize the delay in output from the buffer has been disclosed (see, JP-A-2015-192392).

However, the conventional apparatus (JP-A-2009-171513 or the like) needs monitoring the frequencies of a plurality of clocks, the amount of data accumulated in the buffer of the apparatus, and the like. This poses a problem that occurrence of frame repeating or skipping cannot be completely prevented.

### SUMMARY OF THE INVENTION

It is an object of the present disclosure to at least partially solve the problems in the conventional technology.

An video-processing apparatus according to one aspect of the present disclosure includes a digitizing unit that, when subdivided data in which a frame is subdivided is received via a network, acquires values of the number of samples and the number of lines in a frame being output, and an output clock controlling unit that controls a video output clock based on the values and reference values of the number of samples and the number of lines as references for the video output clock.

An video-processing method according to another aspect of the present disclosure includes a digitizing step of acquiring values of the number of samples and the number of lines in a frame being output, when subdivided data in which a frame is subdivided is received via a network, and an output clock controlling step of controlling a video output clock based on the values and reference values of the number of samples and the number of lines as references for the video output clock.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a hardware configuration diagram of an example of a schematic configuration of a video-processing system according to an embodiment;

FIG. 2 is a hardware configuration diagram of an example of a configuration of the video-processing system according to the embodiment;

FIG. 3 is a block diagram of an example of a configuration of a video-processing apparatus 100 according to the embodiment;

FIG. 4 is a flow diagram of an example of a process performed by the video-processing apparatus 100 according to the embodiment;

FIG. 5 is a flow chart of an example of a process performed by the video-processing apparatus 100 according to the embodiment;

FIG. 6 is a diagram of an example of the number of samples and the number of lines according to the embodiment;

FIG. 7 is a conceptual diagram of an example of a video output timing digitization process according to the embodiment;

FIG. 8 is a diagram of an example of a clock generation process according to the embodiment;

FIG. 9 is a diagram of video output timings at frame receipt times;

FIG. 10 is a diagram of video output timings at frame receipt times;

FIG. 11 is a diagram of video output timings at frame receipt times;

FIG. 12 is a diagram of video output timings at frame receipt times;

FIG. 13 is a diagram of video output timings at frame receipt times;

FIG. 14 is a diagram of an example of video output clock adjustment according to the embodiment;

FIG. 15 is a diagram of an example of buffer amount transition according to the embodiment; and

FIG. 16 is a diagram of an example of buffer amount transition according to the embodiment.

### DETAILED DESCRIPTION OF THE PREFERRED EMBODIMENTS

Embodiments of a video-processing apparatus and a video-processing method according to the present disclosure will be explained below in detail with reference to the drawings. However, the present disclosure is not limited to the embodiments.

Configuration of Embodiment

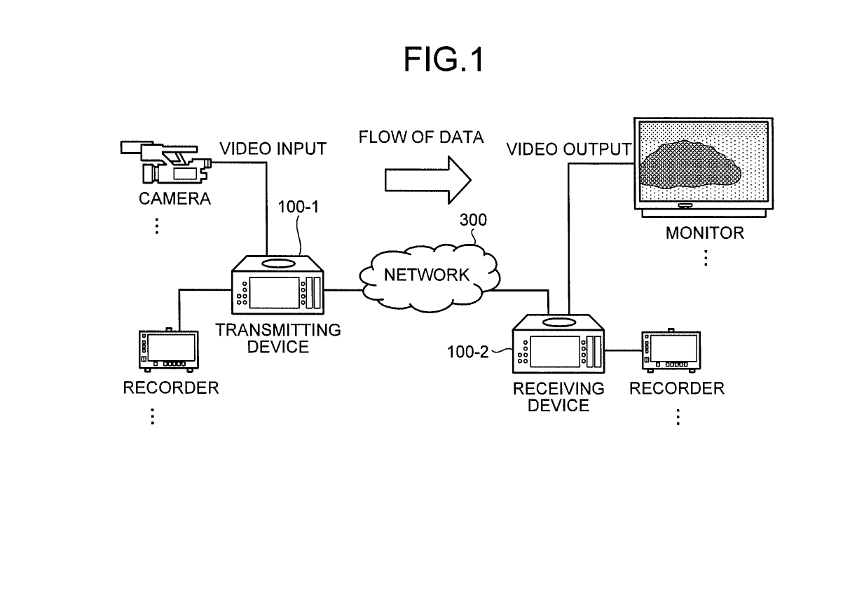

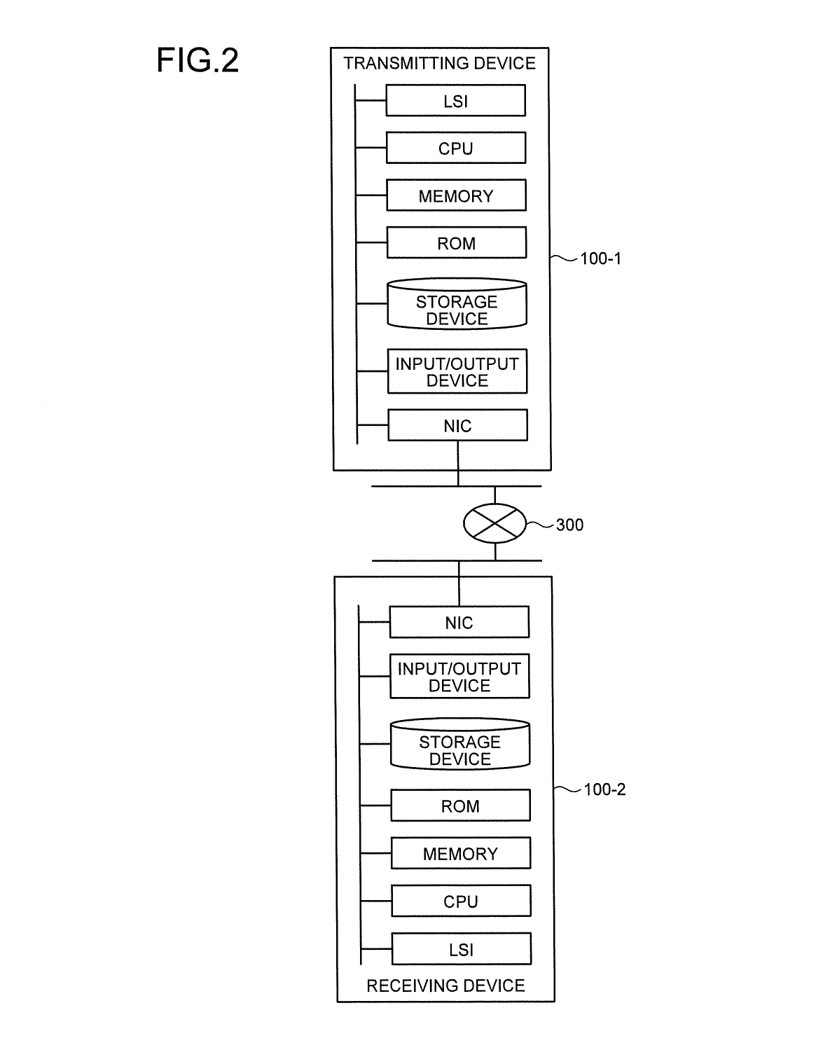

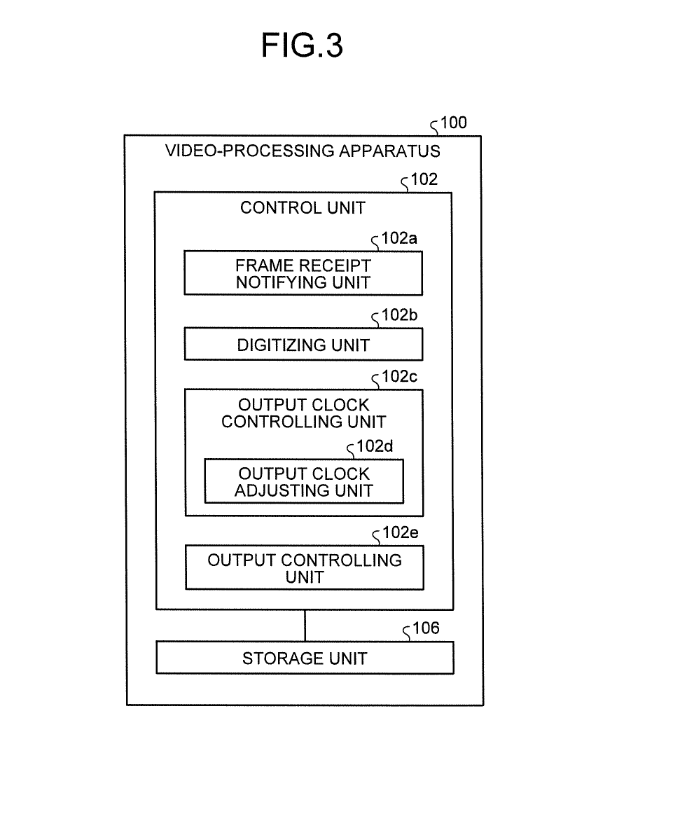

An example of a configuration of a video-processing apparatus 100 according to an embodiment of the present disclosure will be explained with reference to FIGS. 1 to 3, and then processes and the like according to the embodiment will be explained in detail. FIG. 1 is a hardware configuration diagram of an example of a schematic configuration of a video-processing system according to the embodiment. FIG. 2 is a hardware configuration diagram of an example of a configuration of the video-processing system according to the embodiment. FIG. 3 is a block diagram of an example of a configuration of the video-processing apparatus 100 according to the embodiment.

However, the embodiments explained below merely exemplify the video-processing apparatus 100 for carrying out the technical idea of the present disclosure and is not intended to specify the present disclosure as the video-processing apparatus 100. The present disclosure is also applicable equally to the video-processing apparatus 100 according to other embodiments included in the claims.

For example, the mode of function distribution in the video-processing apparatus 100 according to the embodiment is not limited to the following one but the video-processing apparatus 100 can be formed by distributing or integrating functionally or physically arbitrary units within the range in which the same effects and functions can be produced.

As shown in FIGS. 1 and 2, the video-processing system is schematically formed by connecting communicably a video-processing apparatus (transmitting device) 100-1 and a video-processing apparatus (receiving device) 100-2 via a network 300.

As shown in FIG. 1, (input) video data is output from a camera, a recorder, or the like, and is then input into the transmitting device 100-1. The transmitting device 100-1 transmits the video data to the network 300.

Then, the receiving device 100-2 receives the video data transmitted through the network 300. When the receiving device 100-2 outputs (output) video data, the (output) video data is input into a monitor, a recorder, or the like.

As shown in FIG. 2, the video-processing apparatus 100 constituting the video-processing system may include an LSI for a process of converting video data (frame) into subdivided data (IP data) in which a frame is subdivided, a process for transmitting and receiving the subdivided data, clock control, and others, and a central processing unit (CPU) for arithmetic operations.

The video-processing apparatus 100 may also include a memory, a ROM, and a storage device (buffer) for buffering the video data, an arbitrary number of input/output devices for inputting and outing the video, and a network interface (NIC) for transmitting and receiving the subdivided data.

The input/output devices may be serial digital interface (SDI) terminals, high-definition multimedia interface (HDMI) (registered trademark) terminals, display port terminals, or the like.

As shown in FIG. 2, a camera, a recorder, or the like may be connected to an input port constituting the input/output device, and a monitor (display), a recorder, or the like may be connected to an output port constituting the input/output device.

As the LSI, a chip of FPGA or CPU may be mounted. The storage device may be a RAM, a solid state drive (SSD), a hard disk drive (HDD), or the like.

The NIC may be a twisted-pair cable, or an optical transceiver module such as a Small Form-factor Pluggable+(SFP+) or 10 Gigabit Small Form Factor Pluggable (XFP).

As shown in FIG. 3, the video-processing apparatus 100 is generally configured to include a control unit 102 and a storage unit (buffer) 106. These components of the video-processing apparatus 100 are communicably connected together via an arbitrary communication path.

The video-processing apparatus 100 may further include an input/output unit (not illustrated) that has the function of inputting and outputting (I/O) of data.

The input/output unit may be a key input unit, a touch panel, a control pad (for example, a touch pad, a game pad, or the like), a mouse, a keyboard, a microphone, or the like.

The input/output unit may be a display unit displaying (input/output) information such as applications (for example, a display, a monitor, a touch panel, or the like composed of liquid crystal, organic EL, or the like). The input/output unit may be a sound output unit outputting audio information as sound (for example, a speaker or the like).

The storage unit (buffer) 106 stores any one, some, or all of various databases, tables, and files. The storage unit 106 may store video data, subdivided data, and the like. The storage unit 106 may also store various application programs (for example, user applications and the like).

The storage unit 106 is a storage unit that may be any one, some, or all of a memory such as a RAM or a ROM, a fixed disk device such as an HDD, an SSD, a flexible disk, and an optical disk. The storage unit 106 may store computer programs and the like for providing the CPU with instructions to perform various processes.

The buffer 106 may temporarily save the video data received via the network 300. The buffer 106 may be capable of recognizing the video data frame by frame, and save the video data making a distinction between the frames.

The control unit 102 includes a CPU performing a centralized control of the video-processing apparatus 100 and the like. The control unit 102 has an internal memory for storing control programs, programs defining various process procedures and the like, and required data. The control unit 102 performs information processing to execute various processes based on these programs.

The control unit 102 includes as conceptual functions a frame receipt notifying unit 102a, a digitizing unit 102b, an output clock controlling unit 102c, and an output controlling unit 102e.

The frame receipt notifying unit (frame arrival notifying unit) 102a receives via the network 300 the subdivided data in which a frame (one frame of video data) is subdivided.

When the subdivided data includes the head data of the frame, the frame arrival notifying unit 102a recognizes the head data and transmits a frame receipt notification to the digitizing unit 102b. That is, the frame receipt notifying unit 102a may notify the arrival of the frame.

Alternatively, the frame arrival notifying unit 102a may receive the subdivided data via the network 300. When the subdivided data includes head specification data of the frame under a predetermined standard or includes unique head specification data of the frame, the frame arrival notifying unit 102a may recognize the head specification data and transmit a frame receipt notification to the digitizing unit 102b.

The head specification data included in the subdivided data may be information on a MPEG2-transport stream (TS) header (payload start indicator or the like), a special identifier in a JPEG2000 image, or any other unique header.

The digitizing unit (video output timing digitizing unit) 102b acquires values of the number of samples and the number of lines in the frame. That is, the video output timing digitizing unit 102b may digitize a video output timing.

When the subdivided data in which the frame is subdivided is received via the network 300, the video output timing digitizing unit 102b may acquire the values of the number of samples and the number of lines in the frame being output.

When the subdivided data is received via the network 300, the video output timing digitizing unit 102b may also generate a video output clock and a timing pulse indicating the top of the frame, and acquire the values of the number of samples and the number of lines in the frame being output based on the timing pulse.

When receiving the frame receipt notification, the video output timing digitizing unit 102b may acquire the values of the number of samples and the number of lines in the frame being output.

The output clock controlling unit (video output clock controlling unit) 102c controls a video output clock. In this example, the video output clock controlling unit 102c may control the video output clock based on the values acquired by the video output timing digitizing unit 102b and reference values of the number of samples and the number of lines as references for the video output clock.

When the values acquired by the video output timing digitizing unit 102b are larger than the reference values, the video output clock controlling unit 102c may control the video output clock to delay the timing for video output, and when the values acquired by the video output timing digitizing unit 102b are smaller than the reference values, the video output clock controlling unit 102c may control the video output clock to advance the timing for video output.

The reference values may be values of the number of samples and the number of lines in the frame being output acquired by the video output timing digitizing unit 102b at a predetermined point in time.

The predetermined point in time may be the point in time when the amount of data accumulated in the buffer 106 has exceeded half of the capacity of the buffer 106. Alternatively, the predetermined point in time may be the point in time when the amount of data accumulated in the buffer 106 has exceeded a buffer lower limit as a capacity of the buffer 106 without occurrence of frame repeating.

The video output clock controlling unit 102c includes at least an output clock adjusting unit (video output clock adjusting unit) 102d as shown in FIG. 3.

The video output clock adjusting unit 102d adjusts the video output clock. The video output clock adjusting unit 102d may adjust the video output clock by changing the voltage.

The video output clock adjusting unit 102d may adjust the video output clock under the control by the video output clock controlling unit 102c. Specifically, the video output clock controlling unit 102c may determine how to control the video output clock adjusting unit 102d by use of the values acquired by the video output timing digitizing unit 102b.

The output controlling unit 102e outputs the frame stored in the buffer 106. The output controlling unit 102e may output the frame stored in the buffer 106 (to a monitor, a recorder, or the like) based on the video output clock controlled by the video output clock adjusting unit 102d.

Processes According to Embodiment

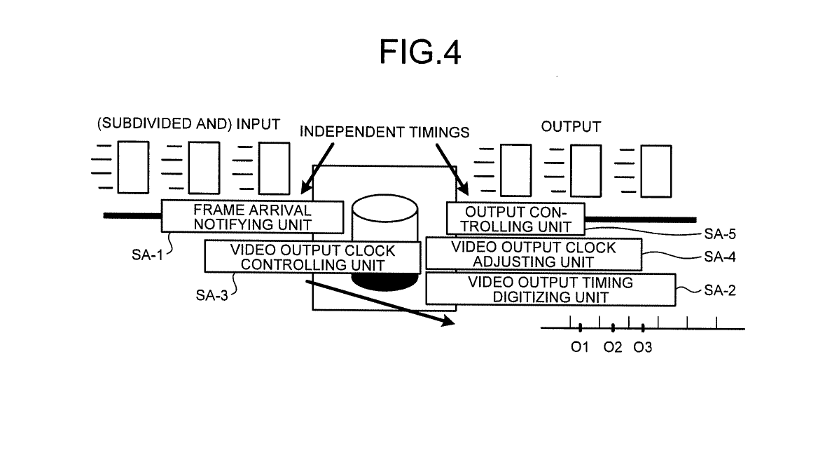

Examples of processes executed by the thus configured video-processing apparatus 100 will be explained with reference to FIGS. 4 to 16. FIG. 4 is a flow diagram of an example of a process performed by the video-processing apparatus 100 according to the embodiment.

As shown in FIG. 4, first, the frame arrival notifying unit 102a receives the subdivided data in which the frame is subdivided via the network 300. When the subdivided data includes head specification data of the frame under a predetermined standard or unique head specification data of the frame, the frame arrival notifying unit 102a recognizes the head specification data and transmits a frame receipt notification to the digitizing unit 102b (step SA-1).

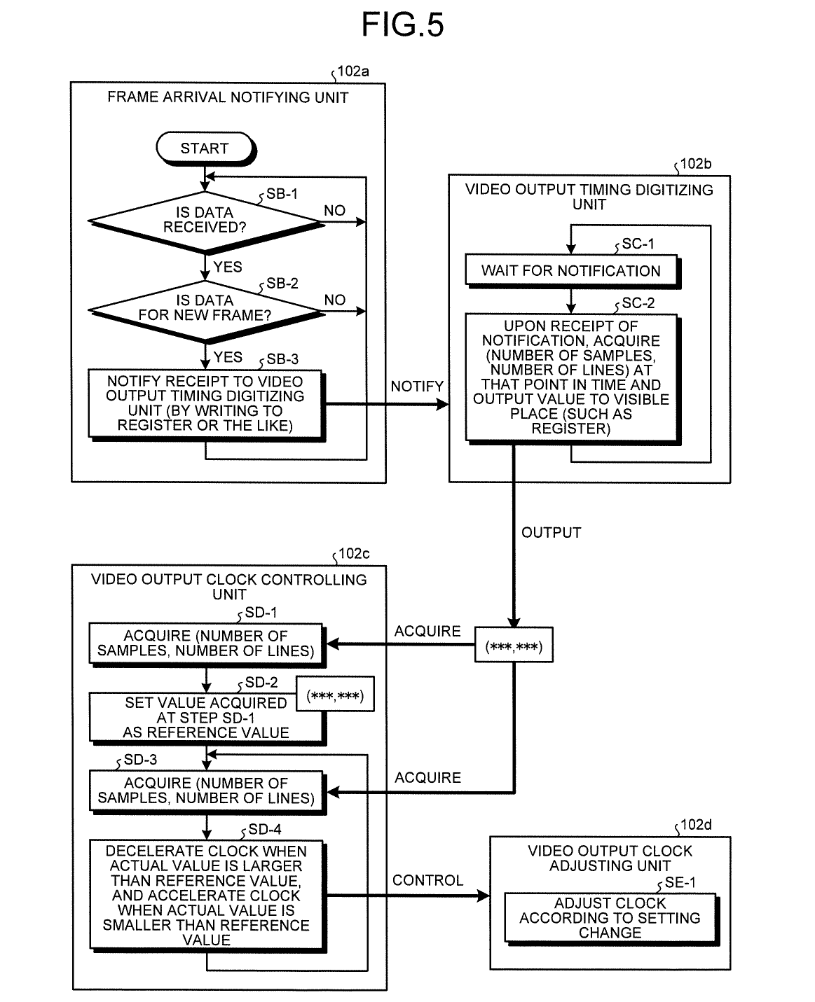

An example of a frame arrival notification process according to the embodiment will be explained with reference to FIG. 5. FIG. 5 is a flow chart of an example of a process performed by the video-processing apparatus 100 according to the embodiment.

As shown in FIG. 5, first, the frame arrival notifying unit 102a determines whether the subdivided data has been received via the network 300 (step SB-1).

When the frame arrival notifying unit 102a determines that no subdivided data has been received via the network 300 (No at step SB-1), the processing is repeated (the processing is shifted to step SB-1) (after waiting).

On the other hand, when the frame arrival notifying unit 102a determines that the subdivided data has been received via the network 300 (Yes at step SB-1), the processing is shifted to step SB-2.

The frame arrival notifying unit 102a then determines whether the received subdivided data is data of a new frame (step SB-2).

When the frame arrival notifying unit 102a determines that the received subdivided data is not data of a new frame (No at step SB-2), the processing is shifted to step SB-1.

On the other hand, when the frame arrival notifying unit 102a determines that the received subdivided data is data of a new frame (Yes at step SB-2), the processing is shifted to step SB-3.

Then, the frame arrival notifying unit 102a notifies the receipt (transmits a frame receipt notification) to the video output timing digitizing unit 102b (by writing to a register or the like) (step SB-3), and then the processing is shifted to step SB-1.

Returning to FIG. 4, when receiving the frame receipt notification, the video output timing digitizing unit 102b generates a video output clock and a timing pulse indicating the top of the frame, and acquires by the output controlling unit 102e the values of the number of samples and the number of lines in the frame being output based on the timing pulse (step SA-2).

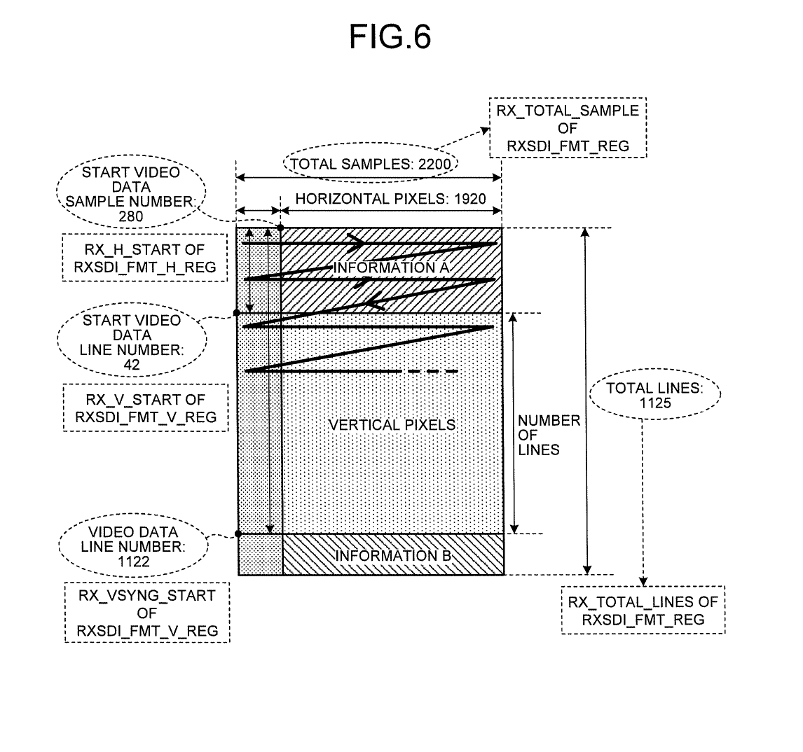

Referring to FIG. 6, an example of the number of samples and the number of lines according to the embodiment will be explained. FIG. 6 is a diagram of an example of the number of samples and the number of lines according to the embodiment.

As shown in FIG. 6, a frame (data of one image) is configured under standards for digital video transmission (for example, SMPTE292 or the like), and is processed as shown by arrows in the data (rectangle) in a zigzag manner from left to right and from top to down, that is, from upper left to lower right.

As shown by arrows outside the data (rectangle), the frame has total samples and total lines in vertical and horizontal directions. By specifying their values, it is possible to identify the part of all the data constituting the frame.

Referring to FIG. 6, the number of the horizontal pixels may be 2200−280=1920. Referring to FIG. 6, the number of the vertical pixels may be 1122−42=1080.

Referring to FIG. 5, an example of a video output timing digitization process according to the embodiment will be explained.

As shown in FIG. 5, first, the video output timing digitizing unit 102b waits until receipt of a frame receipt notification (step SC-1).

Then, upon receipt of the notification, the video output timing digitizing unit 102b acquires (the number of samples, the number of lines) at that point in time, outputs the same as numeric values to a visible place (such as a register) (step SC-2), and then the processing is shifted to step SC-1.

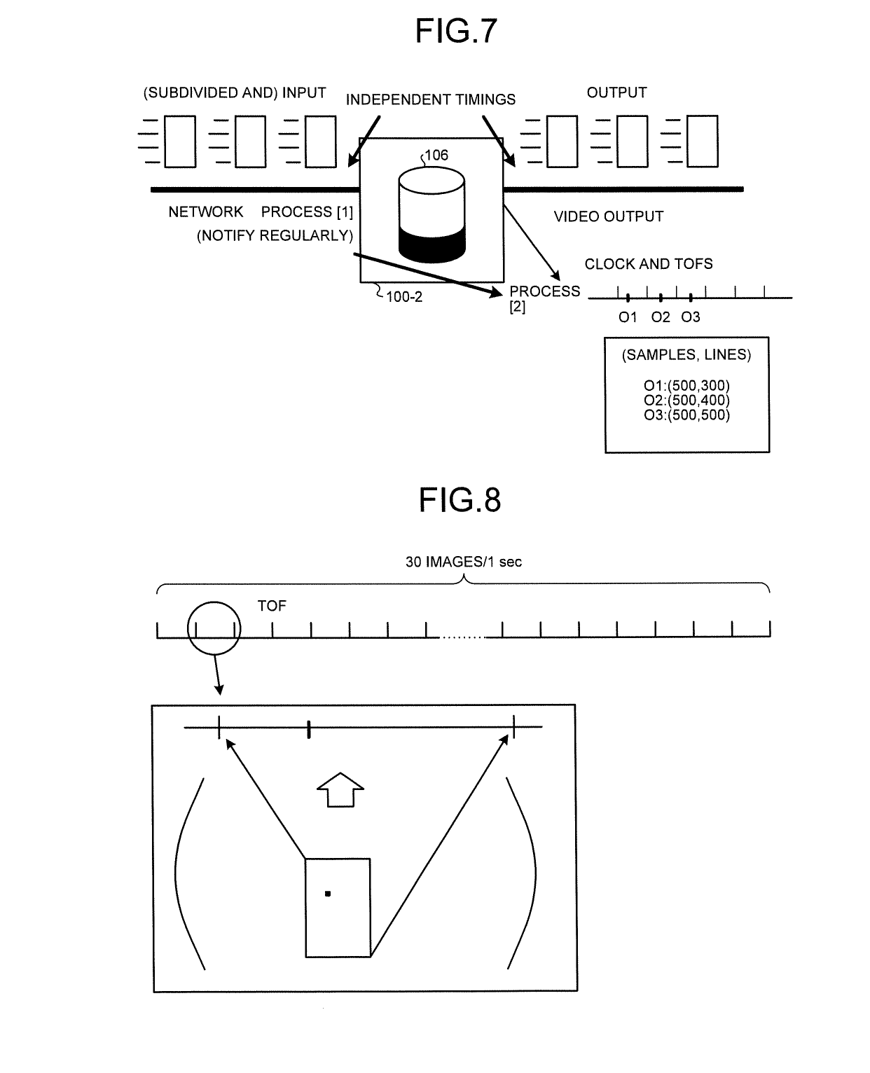

Further, referring to FIG. 7, an example of a video output timing digitization process according to the embodiment will be explained. FIG. 7 is a conceptual diagram of an example of a video output timing digitization process according to the embodiment.

As shown in FIG. 7, first, image data (frame) is subdivided, an MPEG2-TS header or the like is affixed to the subdivided data, and the subdivided data is transferred to the receiving device 100-2 via the network 300.

The intervals between the incoming subdivided data vary depending on any one or both of the input clock of the video data input into the transmitting device 100-1 from a photographing device or the like and the quality of the network 300. However, the intervals may be almost equal.

Upon receipt of new image data (frame), the frame arrival notifying unit 102a of the receiving device 100-2 notifies the receipt to the video output timing digitizing unit 102b (process [1]). The frame arrival notifying unit 102a may repeatedly notify the arrival of each new frame.

That is, upon receipt of the subdivided data at almost equal intervals, the frame arrival notifying unit 102a of the receiving device 100-2 transmits frame receipt notifications at almost equal intervals. The receiving device 100-2 may include a mechanism for accumulating the data such as the buffer 106.

The video output timing digitizing unit 102b of the receiving device 100-2 digitizes the value of (the number of samples, the number of lines) in the data being output at the point in time when the notification of receipt of a new frame is received (for example, such as O1: (500, 300), O2: (500, 400), and O3: (500, 500) illustrated in FIG. 7) (process [2]).

The video output timing digitizing unit 102b may digitize the data on receipt of each notification of receipt of a new frame.

The receiving device 100-2 receives the receipt notifications according to the incoming of image data at almost equal intervals, and digitizes those output timings. Accordingly, the clock of video output does not completely match the clock of video data input into the transmitting device 100-1, and the value of the clock gradually changes.

As shown in FIG. 7, the timing for image data input into the receiving device 100-2 and the timing for video output from the receiving device 100-2 may be independent from each other. In addition, the top of the frame (TOF) of video output is not necessarily decided to be the TOF of specific image data.

Referring to FIG. 8, an example of a clock generation process according to the embodiment will be explained. FIG. 8 is a diagram of an example of a clock generation process according to the embodiment.

As shown in the upper part of FIG. 8, the video-processing apparatus 100 may include a chip such as LMH1983, for example, to generate the video output clock and the timing pulse indicative of the top of the frame (TOF).

As shown in FIG. 8, the intervals between the adjacent TOFs constitutes the times for one image. For example, when the video output clock is set to be output at 30 fps (frames per second), 30 TOFs are inserted in one second.

The video output clock and the timing pulse indicative of the TOF may be uniformly ticked and notified regardless of the received video image data, and be used in the hardware (the video-processing apparatus 100).

The lower part of FIG. 8 illustrates an extracted time for one image between the TOFs. At 30 fps, the interval between the TOFs becomes about 0.03333 . . . second.

As shown in the lower part of FIG. 8, the location of the subdivided data in the frame (for example, the timing for video output or the like) may be expressed as (the number of samples, the number of lines) in a square. Alternatively, the location of the subdivided data may be expressed in a simple horizontal axis because the data is continuous from left to right and from top to down, that is, from upper left to lower right in a zigzag manner.

For example, the scale at the left end of the horizontal axis illustrated in the lower part of FIG. 8 may indicate the top (0, 0), and the scale at the right end of the horizontal axis may indicate the end (2199, 1124).

In addition, as shown in the lower part of FIG. 8, the interval between the TOFs is the time for one image that may be expressed as (the number of samples, the number of lines).

Specifically describing with reference to FIG. 6, the video-processing apparatus 100 can acquire (the number of samples, the number of lines) by dividing equally the one-image time of 0.0333 . . . second by 2475000 (2200 (the total number of samples) by 1125 (the total number of lines)).

For example, at 0.0000 second, the video-processing apparatus 100 may acquire (the number of samples, the number of lines) as (0, 0). At 0.1666 second, the video-processing apparatus 100 may acquire (the number of samples, the number of lines) as (1100, 562).

At 0.3333 second, the video-processing apparatus 100 may acquire (the number of samples, the number of lines) as (2199, 1124). Therefore, the point in the frame at the lower part of FIG. 8 is positioned at ⅓ and is expressed as (733, 375).

Returning to FIG. 4, when the values acquired by the video output timing digitizing unit 102b are larger than the reference values of the number of samples and the number of lines as reference for the video output clock, the video output clock controlling unit 102c controls the video output clock adjusting unit 102d to delay the timing for video output, and when the values acquired by the video output timing digitizing unit 102b are smaller than the reference values, the video output clock controlling unit 102c controls the video output clock adjusting unit 102d to advance the timing for video output (step SA-3).

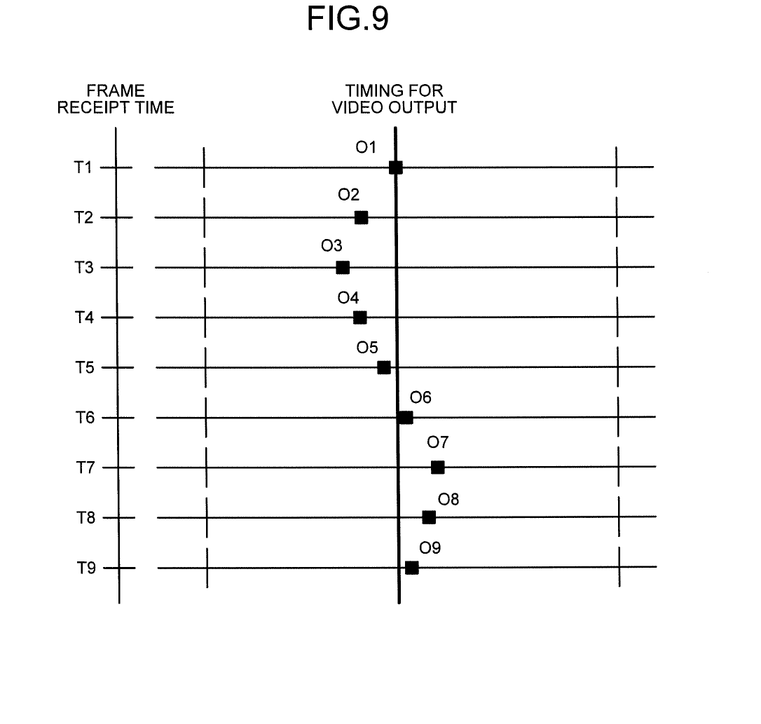

Referring to FIGS. 5 and 9 to 13, an example of a video output clock control process according to the embodiment will be explained. FIG. 9 is a diagram of video output timings at frame receipt times.

As shown in FIG. 5, the video output clock controlling unit 102c acquires (the number of samples, the number of lines) in the frame being output that was acquired by the video output timing digitizing unit 102b at a predetermined point in time (step SD-1).

The video output clock controlling unit 102c sets (the number of samples, the number of lines) acquired at step SD-1 as reference value (step SD-2).

The video output clock controlling unit 102c acquires the value of (the number of samples, the number of lines) in the frame being output that was acquired by the video output timing digitizing unit 102b (step SD-3).

The video output clock controlling unit 102c controls the video output clock adjusting unit 102d to delay the clock when the value acquired at step SD-3 is larger than the reference value, and controls the video output clock adjusting unit 102d so as to accelerate the clock when the value acquired at step SD-3 is smaller than the reference value (step SD-4), and then the processing is shifted to step SD-3.

As shown in FIG. 9, after acquiring a first video output timing O1, the video-processing apparatus 100 may accelerate or decelerate the clock for video output to keep the timings constant with reference to the acquired timing.

Specifically, the timing for video output at time T1 when a frame 1 was received is O1, and the video-processing apparatus 100 controls the timing O1 to be kept constant (on the line in the drawing).

First, from time T1 to time T3, the clock for video output is less advanced than the clock for input video, and the timing for video output shifts gradually forward such as from O2 to O3.

Accordingly, if this goes on, the data will become saturated from time T3 to time T5 and need skipping. The video-processing apparatus 100 detects that (the number of samples, the number of lines) at O2 and O3 are smaller than that at O1, and then accelerates the clock.

By performing such a control, the process for video output becomes accelerated and the timing for video output shifts gradually backward.

Meanwhile, from time T5 to time T7, the clock for video output is more advanced than the clock for input video, and the timing for video output shifts gradually backward such as from O6 to O7.

Accordingly, if this goes on, the data will become depleted and need repeating from time T7 to time T9. The video-processing apparatus 100 detects that (the number of samples, the number of lines) at O6 and O7 are larger than that at O1, and then decelerates the clock.

By performing such a control, the process for video output becomes decelerated and the timing for video output shifts gradually forward.

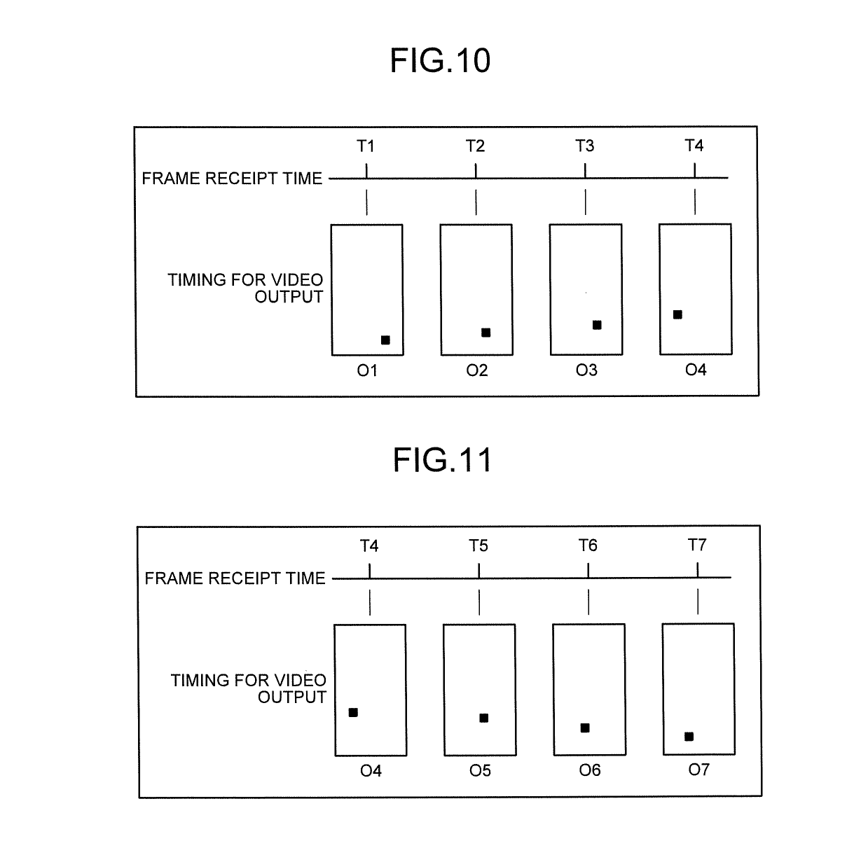

Referring to FIGS. 10 to 13, a specific example of a video output clock control process according to the embodiment will be explained. FIGS. 10 to 13 are diagrams of video output timings at frame receipt times.

As shown in FIG. 10, the video-processing apparatus 100 can recognize the timings O (1, 2, 3, and 4) for video output at times T (1, 2, 3, and 4) when the frames were received, as (samples, lines) in the frame being output.

Referring to FIG. 10, the timings for video output are less advanced than the incoming times of the frames, and the location of the data being processed shifts gradually forward, that is, in the direction in which (samples, lines) in the output frame decrease.

That is, referring to FIG. 10, the clock for input video and the clock for output video from the video-processing apparatus 100 are not synchronized, and if this goes on, the data will continue to be accumulated and need skipping.

Accordingly, as shown in FIG. 11, the video-processing apparatus 100 accelerates the clock for video output at time T4 to speed up the process such that the location of the data being processed shifts gradually backward, that is, in the direction in which (samples, lines) in the frame being output increase. This keeps the video-processing apparatus 100 from being in the state in which skipping is necessary.

That is, according to the embodiment, when the timing shifts forward with reference to a certain timing for video output, the clock for input video is more advanced than the clock for video output, and therefore the clock may be accelerated to output the frame at a higher speed.

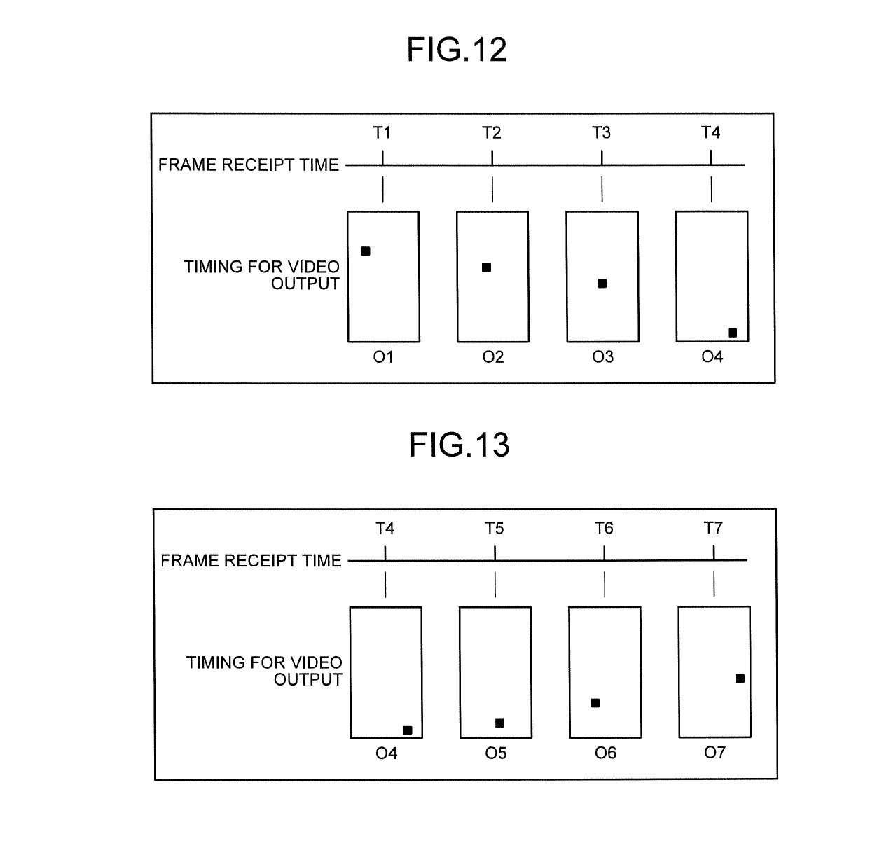

Next, referring to FIG. 12, the timings for video output are more advanced than the incoming times of the frames, and the location of the data being processed moves gradually backward, that is, in the direction in which (samples, lines) in the output frame increase.

That is, referring to FIG. 12, the clock for input video and the clock for output video from the video-processing apparatus 100 are not synchronized, and if this goes on, the data will become depleted and need repeating.

Accordingly, as shown in FIG. 13, the video-processing apparatus 100 decelerates the clock of video output at time T4 to move gradually the location of the processed data forward, that is, in the direction in which (samples, lines) in the output frame decrease. This keeps the video-processing apparatus 100 from being in the state in which repeating is necessary.

That is, according to the embodiment, when the timing shifts backward, the clock for input video is less advanced than the clock for video output. Accordingly, the clock may be decelerated to output the frame at a lower speed.

Returning to FIG. 4, the video output clock adjusting unit 102d changes the voltage under the control by the video output clock controlling unit 102c to adjust the video output (step SA-4).

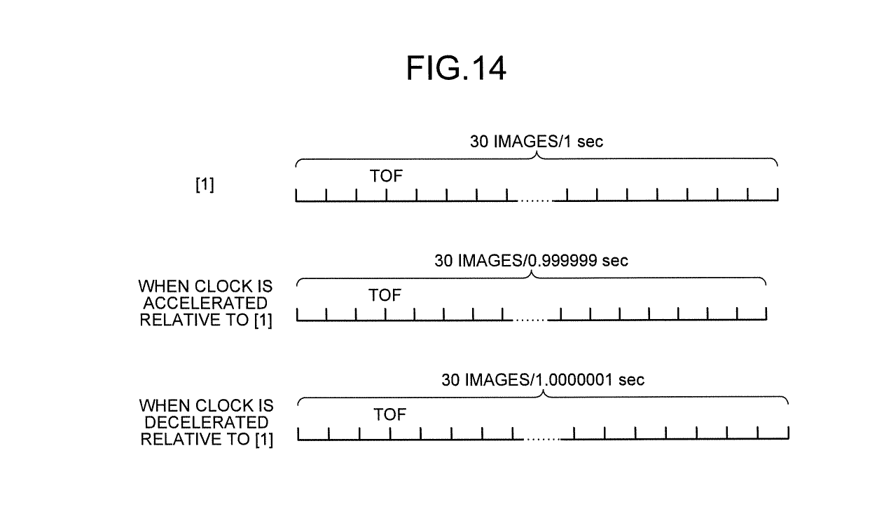

Referring to FIGS. 5 and 14, an example of a video output clock adjustment process according to the embodiment will be explained. FIG. 14 is a diagram of an example of video output clock adjustment according to the embodiment.

As shown in FIG. 5, in response to the setting change (by the register or the like), the video output clock adjusting unit 102d adjusts the video output clock (step SE-1).

As shown in FIG. 14, the video-processing apparatus 100 may include a chip such as an LMH1983 to adjust finely the video output clock.

For example, as shown in FIG. 14, when a 30 fps video output clock [1] as a reference is accelerated, the intervals between TOFs become shorter (the intervals between individual image outputs become shorter), and the video output clock becomes about 30.000030 fps.

Meanwhile, as shown in FIG. 14, when the 30 fps video output clock [1] as a reference is decelerated, the intervals between TOFs become longer (the intervals between individual image outputs become shorter), and the video output clock becomes about 29.999997 fps.

As in the foregoing, according to the embodiment, by changing minutely the video output clock, the intervals between TOFs become shorter or longer as shown in the lower part of FIG. 8 to exert influence on the values of (the number of samples, the number of lines) in the frame being output on receipt of a notification of receipt of a new frame and control the values of (the number of samples, the number of lines).

Returning to FIG. 4, the output controlling unit 102e outputs the frames stored in the buffer 106 to the monitor or the recorder based on the video output clock controlled by the video output clock adjusting unit 102d (step SA-5), and then the processing is ended.

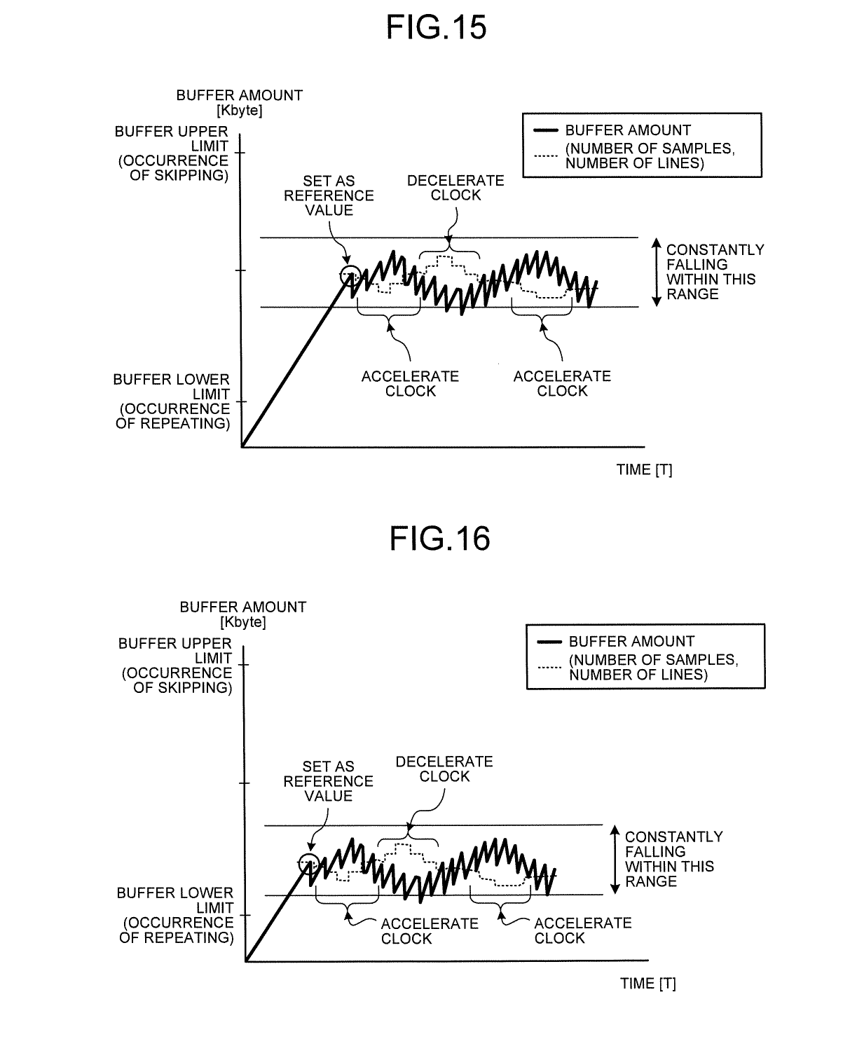

Referring to FIGS. 15 and 16, an example of buffer amount transition according to the embodiment will be explained. FIGS. 15 and 16 are diagrams of examples of buffer amount transition according to the embodiment.

FIG. 15 illustrates transitions of the buffer amount and (the number of samples, the number of lines) with reference to (the number of samples, the number of lines) in the acquired output when the reference point (reference value) has exceeded half of the capacity of the buffer 106.

As shown in FIG. 15, starting this control when about half of the buffer amount has been reached makes it unlikely to generate repeating and skipping with higher repeating resistance and skipping resistance.

As in the foregoing, according to the embodiment, the buffer 106 may have a somewhat larger capacity than the data size of one image to be transmitted and received, so that images are received until data is accumulated in about half of the buffer 106 and then this control is performed.

Accordingly, according to the embodiment, the buffer accumulation amount is kept at about half of the buffer 106 to prevent the situation in which the buffer accumulation amount reaches the lower limit or the upper limit of the buffer 106 to subject the video data to skipping or repeating process.

FIG. 16 illustrates the transitions of the buffer amount and (the number of samples, the number of lines) with reference to the values of (the number of samples, the number of lines) in the acquired output when the reference point (reference value) has exceeded the buffer lower limit as the capacity of the buffer 106 without occurrence of repeating.

As shown in FIG. 16, starting this control at a point slightly above the buffer lower limit, the delay can be reduced although the resistance to repeating is low.

Referring to FIGS. 15 and 16, according to the embodiment, it is possible to perform a control to shift the buffer amount to prevent occurrence of repeating and skipping.

A conventional model of transmission apparatus inputs video, transmits data to an opposing device via a network, receives data from the opposing device, and outputs video.

In this conventional model, when a buffer is provided at the data receiving (video outputting) apparatus to absorb fluctuations in the data arrival time, minute differences between the clock for input video and the video output clock from the video outputting apparatus generate increase or decrease in the amount of data accumulated in the buffer.

In such a situation, in the conventional model, (1) when the data becomes insufficient at the timing for output, the previous image is output again (repeated), and (2) when the data is about to overflow beyond the limit for accumulation in the buffer, one of the accumulated images is discarded (skipped).

In the conventional model, by performing the buffer data accumulation amount controls (1) and (2), the system does not become failed even when the data is depleted or saturated, thereby continuing video transmission.

However, in the conventional model, outputting repeatedly an image or deleting an image results in the problem that the video is changed.

According to the embodiment, there are individual differences between the devices and no completely identical clocks can be obtained. Therefore, a control is performed such that, even when there is a difference between the clock for input video and the video output clock from the video outputting apparatus, the amount of data accumulated in the buffer of the video outputting apparatus does not decrease to the data depleted state or increase to the data saturated state requiring repeating process or skipping process.

That is, according to the embodiment, the video output clock is adjusted such that the timing for video output at the frame receipt time is always constant.

As a result, the embodiment solves the problem that, even when the clock for input video (clock for the input video-outputting device to output the video) and the clock for the receiving device 100-2 to output the video are set to allow outputting at the same frame rate, the two clocks are not completely identical in a rigorous manner to cause minute differences.

Further, the embodiment also solves the problem that, even when the same components are used at the transmitting side and the receiving side, one of the clocks is accelerated or decelerated than the other due to individual differences between the two to decrease or increase the amount of data accumulated in the buffer.

As described above, the frame receipt time varies depending on the time of transmission from the transmitting device 100-1 (the clock for input video), and therefore cannot be controlled by the receiving device 100-2.

According to the embodiment, however, the timing for video output can be freely changed by controlling the video output clock from the receiving device 100-2. The frames can be output at a higher speed or a lower speed by controlling dynamically the video output clock in accordance with the timing for video output at the frame receipt time.

Specifically, when the frames arrive at constant intervals and the clock for video output completely matches the clock for input video, the clock for video output is uniform. However, it is not possible to match completely the two clocks in an actual control, and therefore, according to the embodiment, a control is performed to bring the two clocks close to the completely matching state.

### OTHER EMBODIMENTS

The embodiment of the present disclosure has been explained so far. Besides the foregoing embodiment, the present disclosure can also be carried out in various different embodiments within the scope of the technical idea described in the claims.

For example, the video-processing apparatus 100 may perform processing in a standalone mode, or may perform processing according to a request from a client terminal (separate from the video-processing apparatus 100) and then return the results of the processing to the client terminal.

Out of the processes explained in relation to the embodiment, all or some of the processes explained as being automatically performed may be manually performed, or all or some of the processes explained as being manually performed may be automatically performed by publicly known methods.

Besides, the process steps, the control steps, the specific names, the information including registered data for the processes or parameters such as search conditions, the screen examples, or the database configurations described or illustrated herein or the drawings can be arbitrarily changed if not otherwise specified.

The constituent elements of the video-processing apparatus 100 shown in the drawings are conceptual functions and do not necessarily need to be physically configured as shown in the drawings.

For example, all or any part of the processing functions included in the units of the video-processing apparatus 100, in particular, the processing functions performed by the control unit 102 may be implemented by the CPU or programs interpreted and executed by the CPU, or may be implemented by wired logic-based hardware.

The programs including programmed instructions for causing a computer to execute methods according to the present disclosure described later are recorded in non-transitory computer-readable recording media, and are mechanically read by the video-processing apparatus 100 as necessary. Specifically, the computer programs for giving instructions to the CPU to perform various processes in cooperation with an operating system (OS) are recorded in the storage unit 106 such as a ROM or an HDD. The computer programs are loaded into the RAM and executed, and constitute a control unit in cooperation with the CPU.

The computer programs may be stored in an application program server connected to the video-processing apparatus 100 via an arbitrary network, and may be entirely or partly downloaded as necessary.

The programs according to the present disclosure may be stored in computer-readable recording media or may be formed as program products. The “recording media” include any portable physical media such as a memory card, a USB memory, an SD card, a flexible disc, a magneto optical disc, a ROM, an EPROM, an EEPROM, a CD-ROM, an MO, a DVD, and a Blu-ray (registered trademark) disc.

The “programs” constitute data processing methods described in an arbitrary language or by an arbitrary describing method, and are not limited in format such as source code or binary code. The “programs” are not limited to singly-configured ones but may be distributed into a plurality of modules or libraries or may perform their functions in conjunction with another program typified by an OS. Specific configurations for reading the recording media by the units according to the embodiment, specific procedures for reading the programs, or specific procedures for installing the read programs may be well-known configurations or procedures.

The various databases and others stored in the storage unit 106 may be storage units such as any one, some, or all of a memory device such as a RAM or a ROM, a fixed disc device such as a hard disc, a flexible disc, and an optical disc, and may store any one, some, or all of various programs, tables, databases, and web page files for use in various processes and web site provision.

The video-processing apparatus 100 may be an information processing apparatus such as a well-known personal computer or work station, and arbitrary peripherals may be connected to the information processing apparatus. The video-processing apparatus 100 may be embodied by providing the information processing apparatus with software (including programs, data, and the like) for implementing the methods according to the present disclosure.

Further, the specific modes of distribution and integration of the devices are not limited to the ones illustrated in the drawings but all or some of the devices may be functionally or physically distributed or integrated by arbitrary unit according to various additions and the like or functional loads. That is, the foregoing embodiments may be carried out in arbitrary combination or may be selectively carried out.

In the present disclosure, adjustment of video output clocks is allowed such that a video output timing becomes constantly uniform at receipt of frames.

According to the present disclosure, the image-processing apparatus performs a control such that a video output timing becomes constantly uniform at receipt of frames, thereby to achieve synchronization between clocks of an input video and a video output from the video output apparatus.

Consequently, according to the present disclosure, the amount of data accumulated in the buffer can be controlled so as not to be depleted or saturated, which eliminates the need for repeating or skipping of signals. This makes it possible to continue video transmission without any change in the video.

In addition, according to the present disclosure, the video output can be controlled without monitoring the amount of data accumulated in the buffer to prevent the data depleted state or the data saturated state and eliminate frame repeating or skipping.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A video-processing apparatus comprising:
a digitizing unit that, when subdivided data in which a frame is subdivided is received via a network, acquires values of the number of samples and the number of lines in a frame being output; and
an output clock controlling unit that controls a video output clock based on the values and reference values of the number of samples and the number of lines as references for the video output clock.

2. The video-processing apparatus according to claim 1, wherein the output clock controlling unit controls the video output clock to delay a timing for video output when the values are larger than the reference values, and controls the video output clock to advance the timing for video output when the values are smaller than the reference values.

3. The video-processing apparatus according to claim 1, wherein, when the subdivided data is received via the network, the digitizing unit generates the video output clock and a timing pulse indicative of the top of the frame, and acquires the values of the number of samples and the number of lines in the frame being output based on the timing pulse.

4. The video-processing apparatus according to claim 1, further comprising an output controlling unit that outputs a frame stored in a buffer based on the video output clock controlled by the output clock controlling unit.

5. The video-processing apparatus according to claim 1, wherein the reference values are the values of the number of samples and the number of lines in the frame being output acquired by the digitizing unit at a predetermined point in time.

6. The video-processing apparatus according to claim 1, further comprising a frame receipt notifying unit that receives the subdivided data via the network, and when the subdivided data includes head data of the frame, recognizes the head data, and transmits a frame receipt notification to the digitizing unit.

7. The video-processing apparatus according to claim 6, wherein, when receiving the frame receipt notification, the digitizing unit acquires the values of the number of samples and the number of lines in the frame being output.

8. The video-processing apparatus according to claim 6, wherein the frame receipt notifying unit receives the subdivided data via the network, and when the subdivided data includes head specification data under a predetermined standard or unique head specification data, recognizes the head specification data, and transmits the frame receipt notification to the digitizing unit.

9. The video-processing apparatus according to claim 5, wherein the predetermined point in time is a point in time when the amount of data accumulated in the buffer has exceeded half of the capacity of the buffer.

10. The video-processing apparatus according to claim 5, wherein the predetermined point in time is a point in time when the amount of data accumulated in the buffer has exceeded a buffer lower limit as a capacity of the buffer without occurrence of repeating.

11. A video-processing method comprising:
a digitizing step of acquiring values of the number of samples and the number of lines in a frame being output, when subdivided data in which a frame is subdivided is received via a network; and
an output clock controlling step of controlling a video output clock based on the values and reference values of the number of samples and the number of lines as references for the video output clock.

12. The video-processing method according to claim 11, wherein
at the output clock controlling step, the video output clock is controlled to delay a timing for video output when the values are larger than the reference values, and the video output clock is controlled to advance the timing for video output when the values are smaller than the reference values.

13. The video-processing method according to claim 11, wherein,
when the subdivided data is received via the network, at the digitizing step, the video output clock and a timing pulse indicative of the top of the frame are generated, and the values of the number of samples and the number of lines in the frame being output are acquired based on the timing pulse.

14. The video-processing method according to claim 11 further comprising:
an output controlling step of outputting a frame stored in a buffer based on the video output clock controlled by the output clock controlling unit.

15. The video-processing method according to claim 11, wherein
the reference values are the values of the number of samples and the number of lines in the frame being output acquired at the digitizing step at a predetermined point in time.

16. The video-processing method according to claim 11 further comprising:
a frame receipt notifying step of receiving the subdivided data via the network, and recognizing the head data, when the subdivided data includes head data of the frame, and transmitting a frame receipt notification to a digitizing unit.

17. The video-processing method according to claim 16, wherein,
when receiving the frame receipt notification, at the digitizing unit, the values of the number of samples and the number of lines in the frame being output are acquired.

18. The video-processing method according to claim 16, wherein
at the frame receipt notifying step, the subdivided data via the network is received, and when the subdivided data includes head specification data under a predetermined standard or unique head specification data, the head specification data is recognized, and the frame receipt notification is transmitted to the digitizing unit.

19. The video-processing method according to claim 15, wherein
the predetermined point in time is a point in time when the amount of data accumulated in the buffer has exceeded half of the capacity of the buffer.

20. The video-processing method according to claim 15, wherein
the predetermined point in time is a point in time when the amount of data accumulated in the buffer has exceeded a buffer lower limit as a capacity of the buffer without occurrence of repeating.
